(19) United States
(12) Patent Application Publication
(10) Pub. No.: US 2026/0280198 A1
(43) Pub. Date: Sep. 17, 2026

(54) POWER CONNECTOR

(71) Applicant: OUPIIN ELECTRONIC (KUNSHAN) CO., LTD., Kunshan City (CN)

(72) Inventor: Hsin Chih CHEN, Kunshan City (CN)

(21) Appl. No.: 19/250,667

(22) Filed: Jun. 26, 2025

(30) Foreign Application Priority Data
Mar. 11, 2025 (CN) 202510282925.8
Mar. 11, 2025 (CN) 202520417081.9

(51) Int. Cl. H01R 13/66; H01R 12/70; H01R 13/73

(52) U.S. Cl. CPC H01R 13/6683; H01R 12/7088; H01R 13/73

(57) ABSTRACT

A power connector is disclosed in this application. The power connector includes an insulation case, at least one power terminal, at least one conductive plate and at least one signal cable-fixing member. The power terminal has at least one power contact portion and at least one signal trigger portion. When an insert is inserted into a slot of the insulation case, the power contact portion first makes electrical contact with the insert, and the signal trigger portion is forced to move away from the slot and establish electrical contact with the conductive plate for timely triggering a power supply signal.

### CROSS REFERENCE TO RELATED APPLICATIONS

This application claims the benefit of priority of Chinese Patent Application Nos. 202510282925.8 and 202520417081.9, both filed Mar. 11, 2025, the contents of which are all incorporated herein by reference in their entirety.

### FIELD OF ART

The present application relates to a field of connector technology, and more specifically to a power connector.

### BACKGROUND OF DISCLOSURE

The power connector is used to supply power to electrical equipment. For example, the power connector can be mounted to a server rack and connected to a busbar to supply power to the server rack.

At present, the power connector is required to enable hot-plugging with the busbar. However, this operation may generate electrical arcs that could lead to component breakdown or burnout. In order to reduce the generation of electrical arcs, detection terminals are installed in some power connectors, and the detection terminal is used to make electrical contact with the busbar to ensure that the busbar has been inserted into the power connector before supplying the power.

Hence, it is still necessary to provide a more compact and safer power connector.

### BRIEF SUMMARY OF DISCLOSURE

One object of the present application is to provide a power connector employing a power terminal and a conductive plate, wherein the power terminal can directly electrically contact the conductive plate after coming into contact with an insert to trigger a power supply signal, and the power connector does not require an additional signal trigger mechanism and has the characteristics of higher safety, timely power supply, and compact structure.

Other objects and advantages of the present application may be further understood from technical features disclosed by the present application.

To achieve the above objects of the present application, the present application adopts the following technical solution.

A power connector comprises an insulation case, at least one power terminal, at least one conductive plate and at least one signal cable-fixing unit. The insulation case has a slot for inserting an insert. The power terminal is disposed in the insulation case and has at least one power contact portion and at least one signal trigger portion. Wherein, the power contact portion protrudes into the slot and is used to first make electrical contact with the insert when the insert is inserted into the slot, and the signal trigger portion is forced to move in a direction away from the slot after the power contact portion makes electrical contact with the insert. The conductive plate is disposed in the insulation case, is located on one side of the power terminal facing away from the slot and is independent of the power terminal. Wherein, the conductive plate makes electrical contact with the signal trigger portion after the power contact portion makes electrical contact with the insert, and breaks electrical contact with the signal trigger portion after the insert withdraws from the slot and releases the power contact portion. The signal cable-fixing unit is connected to the conductive plate and is used to fix a signal cable. Wherein, the signal cable is connected to the conductive plate and is used to transmit a power supply signal when the conductive plate is in electrical contact with the signal trigger portion.

In one embodiment, the signal cable-fixing unit and the conductive plate are configured as a one-piece structure by a stamping process.

In one embodiment, the signal cable-fixing unit and the conductive plate are configured as a two-piece structure, and the signal cable-fixing unit is welded and connected to the conductive plate.

In one embodiment, the power terminal has multiple power contact portions arranged in a row and multiple signal trigger portions arranged in a row.

In one embodiment, the power terminal is provided with multiple elastic fingers arranged in a row; each of the elastic fingers has a protruding portion formed by bending toward the slot and a free end away from the slot and close to the conductive plate; the protruding portion is used as the power contact portion; and the free end is used as the signal trigger portion.

In one embodiment, the conductive plate is a flat plate; the conductive plate and the power terminal are arranged in parallel along a width direction of the slot, and define a gap; orthographic projections of the power contact portion and the signal trigger portion on the conductive plate fall within the conductive plate.

In one embodiment, the insulation case has a mating side and a mounting side, and the slot is located on the mating side.

In one embodiment, the conductive plate has a conductive connection sheet disposed near a mounting edge, and the mounting edge faces the mounting side; and the signal cable-fixing unit has a first end portion and a second end portion arranged opposite to each other; wherein the first end portion is connected to the conductive connection sheet, and the second end portion is connected to the signal cable.

In one embodiment, the conductive connection sheet is bent into an L-shape, with a vertical section and a horizontal section; the vertical section extends away from the power terminal, and the horizontal section extends toward the mounting side; the first end portion of the signal cable-fixing unit is connected to the horizontal section.

In one embodiment, the power terminal has a power body portion and a power cable connection portion; the multiple elastic fingers are connected to a front end of the power body portion, and the power cable connection portion is connected to a rear end of the power body portion; the power cable connection portion is used to be fixedly connected with at least one power cable.

In one embodiment, the power terminal is bent vertically twice to form a Z-shape; the power cable connection portion is connected with the power cable by a welding plate; and the welding plate is fixed on one side of the power cable connection portion facing the conductive plate.

To achieve the above objects of the present application, the present application also adopts the following technical solution.

A power connector comprises an insulation case, at least one pair of power terminals, at least one pair of conductive plates and at least one pair of signal cable-fixing units. The insulation case has a slot for inserting an insert. The pair of power terminals includes a first power terminal and a second power terminal that have identical structures and are symmetrically arranged in the insulation case. The first power terminal and the second power terminal are located on two opposite vertical sides of the slot for being used to make electrical contact with two opposing insertion surfaces of the insert. Each of the first power terminal and the second power terminal has at least one power contact portion and at least one signal trigger portion. Wherein, the power contact portion protrudes into the slot and is used to first make electrical contact with the insert when the insert is inserted into the slot, and the signal trigger portion is forced to move in a direction away from the slot after the power contact portion makes electrical contact with the insert. The pair of conductive plates include a first conductive plate and a second conductive plate that have identical structures and are symmetrically arranged in the insulation case. The first conductive plate is independent of the first power terminal and is located on a movement path of the signal trigger portion of the first power terminal. The second conductive plate is independent of the second power terminal and is located on a movement path of the signal trigger portion of the second power terminal. Wherein, the first conductive plate makes electrical contact with the signal trigger portion of the first power terminal after the power contact portion of the first power terminal makes electrical contact with the insert, and breaks electrical contact with the signal trigger portion of the first power terminal after the insert withdraws from the slot and releases the power contact portion of the first power terminal. Wherein, the second conductive plate makes electrical contact with the signal trigger portion of the second power terminal after the power contact portion of the second power terminal makes electrical contact with the insert, and breaks electrical contact with the signal trigger portion of the second power terminal after the insert withdraws from the slot and releases the power contact portion of the second power terminal. The pair of signal cable-fixing units include a first signal cable-fixing unit and a second signal cable-fixing unit that have identical structures, are symmetrically arranged in the insulation case, and are respectively connected to the first conductive plate and the second conductive plate. Each of the first signal cable-fixing unit and the second signal cable-fixing unit is used to fix a signal cable.

In one embodiment, each of the first power terminal and the second power terminal is Z-shaped, and has a power body portion and a power cable connection portion; and a distance between the power cable connection portions of the first and second power terminals is less than a distance between the power body portion of the first and second power terminals.

In comparison with the prior art, the power connector of the present application does not generate an arc between the power terminal and the insert during power supply, as the power terminal has already made electrical contact with the insert before power supply. Moreover, the power connector of the present application employs the power terminal to directly contact the conductive plate for triggering a power supply signal, thereby shortening the trigger time of the power supply signal and timely supplying power to the insert. Furthermore, the power connector of the present application also saves space and makes the structure more compact because no additional signal trigger mechanism is required.

### BRIEF DESCRIPTION OF DRAWINGS

FIG. 1 is a perspective schematic view of a power connector and an insert according to one embodiment of the present application;

FIG. 2 is an exploded view of the power connector according to one embodiment of the present application;

FIG. 3 is a side view of internal components of the power connector according to one embodiment of the present application after removing an insulation case, mainly showing relative positions of power terminals and conductive plates;

FIG. 4 is an exploded view of a partial structure of the power connector according to one embodiment of the present application;

FIG. 5 is an exploded view of the partial structure of the power connector shown in FIG. 4 from another angle; and

FIG. 6 is a further disassembled view of the partial structure of the power connector shown in FIG. 4.

### DETAILED DESCRIPTION OF PREFERRED EMBODIMENTS

The following description of every embodiment with reference to the accompanying drawings is used to exemplify a specific embodiment, which may be carried out in the present application. Directional terms mentioned in the present application, such as “top”, “bottom”, “front”, “back”, “left”, “right”, “upper”, “lower” etc., are only used with reference to the orientation of the accompanying drawings. Therefore, the used directional terms are intended to illustrate, but not to limit, the present application.

A power connector of the present application can be installed on a server rack. When an insert, such as a busbar, is inserted into the power connector, power can be supplied to the server rack.

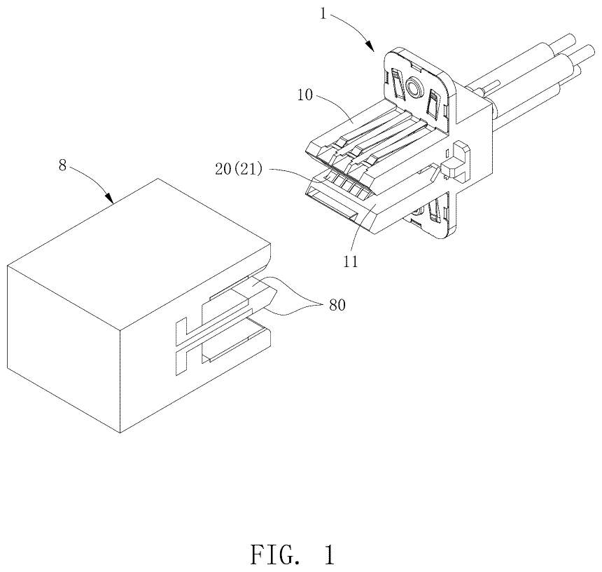

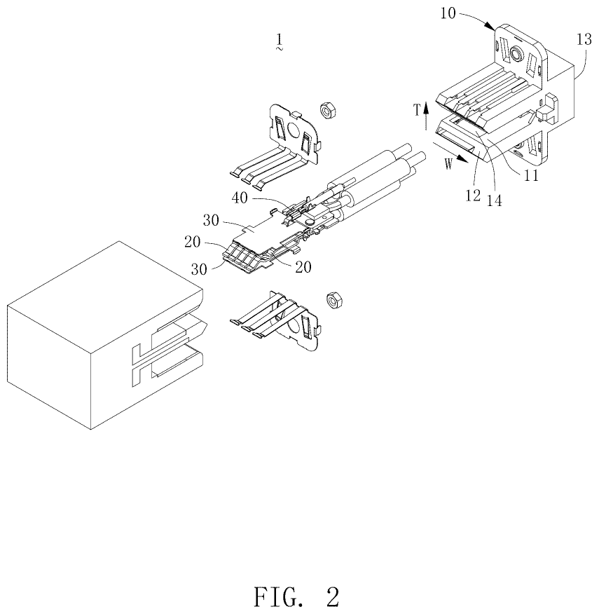

Please refer to FIGS. 1 and 2, in one embodiment of the present application, the power connector 1 includes an insulation case 10, at least one power terminal 20, at least one conductive plate 30 and at least one signal cable-fixing unit 40.

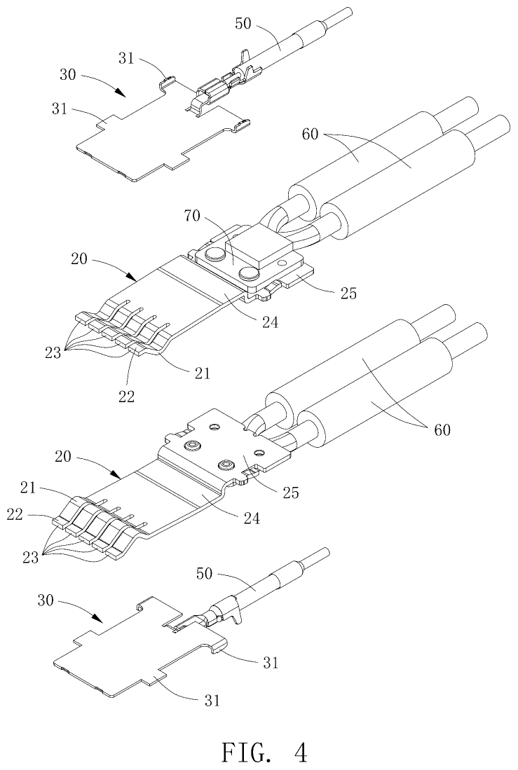

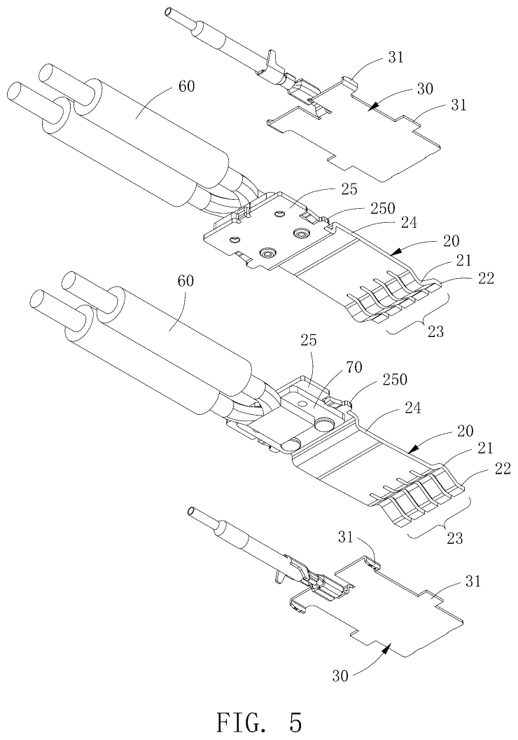

Please refer to FIGS. 1 and 2, the insulation case 10 has a slot 11 for inserting an insert 8. The power terminal 20 is disposed in the insulation case 10. Please refer to FIGS. 4 and 5, the power terminal 20 has at least one power contact portion 21 and at least one signal trigger portion 22. Wherein, the power contact portion 21 protrudes into the slot 11 and is used to first make electrical contact with the insert 8 when the insert 8 is inserted into the slot 11, and the signal trigger portion 22 is forced to move in a direction away from the slot 11 after the power contact portion 21 makes electrical contact with the insert 8. The conductive plate 30 is disposed in the insulation case 10, is located on one side of the power terminal 20 facing away from the slot 11 and is independent of the power terminal 20. Wherein, the conductive plate 30 makes electrical contact with the signal trigger portion 22 after the power contact portion 21 makes electrical contact with the insert 8, and breaks electrical contact with the signal trigger portion 22 after the insert 8 withdraws from the slot 11 and releases the power contact portion 21. The signal cable-fixing unit 40 is connected to the conductive plate 30 and is used to fix a signal cable 50. The signal cable 50 is connected to the conductive plate 30 and is used to transmit a power supply signal when the conductive plate 30 is in electrical contact with the signal trigger portion 22.

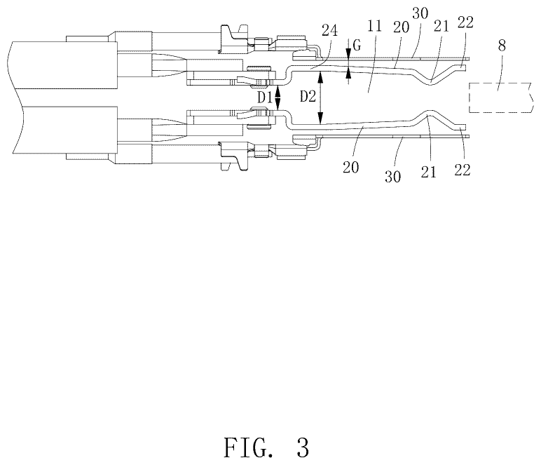

Please refer to FIG. 3, when the insert 8 is inserted into the slot 11, the insert 8 first comes into contact with the power contact portion 21, and then forces the power contact portion 21 to move away from the slot 11, and the signal trigger portion 22 will follow the power contact portion 21 to move away from the slot 11 until the signal trigger portion 22 touches the conductive plate 30. At this time, a power supply system will receive a power supply signal, and the power supply system will supply power to the insert 8. It can be seen that the power connector 1 of the present application does not generate an arc between the power terminal 20 and the insert 8 during power supply because the power terminal 20 has already made electrical contact with the insert 8 before power supply.

The power connector 1 employs the power terminal 20 to contact with the conductive plate 30 to trigger the power supply signal. For example, the signal trigger portion 22 can follow the movement of the power contact portion 21 to trigger the power supply signal. Thus, the power connector 1 of the present application can shorten the trigger time of the power supply signal and timely supply power to the insert 8.

The power connector 1 of the present application employs the power terminal 20 and the conductive plate 30 as a signal trigger mechanism, without the need for additional structures to be served as the signal triggering mechanism, thereby saving space in the insulation case 10 and making the structure of the power connector 1 more compact.

The structural details of the power connector 1 according to the embodiment of the present application will be specifically explained below.

Please refer to FIG. 2, the insulation case 10 has a mating side 12 and a mounting side 13, and the slot 11 is located on the mating side 12. The insulation case 10 further disposes at least one terminal-receiving groove 14, which passes through the mating side 12 and the mounting side 13. The terminal-receiving groove 14 is located on one vertical side (such as a lower side or an upper side in FIG. 2) of the slot 11, and is used to receive the power terminal 20 and the conductive plate 30.

Please refer to FIGS. 4 and 5, in the embodiment, the power terminal 20 has multiple of the power contact portions 21 arranged in a row and multiple of the signal trigger portions 22 arranged in a row.

Specifically, the power terminal 20 is provided with multiple elastic fingers 23 arranged in a row. Each elastic finger 23 has a protruding portion formed by bending toward the slot 11 and a free end away from the slot 11 and close to the conductive plate 30. The protruding portion is used as the power contact portion 21; and the free end is used as the signal trigger portion 22. In other embodiments, other portions of the elastic finger 23 may also be used as the signal trigger portion 22. For example, the signal trigger portion 22 may be disposed on one side of the protruding portion away from the free end, which can also achieve that the signal trigger portion 22 makes electrical contact with the conductive plate 30 only after the power contact portion 21 is in electrical contact with the insert 8. In summary, the signal trigger portion 22 can be disposed on a left side or a right side of the protruding portion. Moreover, the power terminal 20 further has a power body portion 24 and a power cable connection portion 25. The multiple elastic fingers 23 are evenly distributed on a front end of the power body portion 24, and the power cable connection portion 25 is connected to a rear end of the power body portion 24 for being used to be fixedly connected with at least one power cable 60.

Specifically, the power terminal 20 is formed by two vertical bends and is roughly Z-shaped. The power cable connection portion 25 is fixedly connected with the power cable 60 by a welding plate 70. The welding plate 70 is fixed on one side of the power cable connection portion 25 facing the conductive plate 30. Moreover, the power cable connection portion 25 is provided with multiple fixing structures 250 (label seen in FIG. 5) on two side edges of the power cable connection portion 25 to secure the power terminal 20 in the terminal-receiving groove 14.

Please refer to FIGS. 4 and 5, the conductive plate 30 is a flat plate and is provided with multiple wings 31 on two side edges thereof to secure the conductive plate 30 in the terminal-receiving groove 14. The conductive plate 30 and the power terminal 20 are arranged in parallel along a width direction T (label seen in FIG. 2) of the slot 11, and define a gap G (label seen in FIG. 3) therebetween. Specifically, the gap G can be defined between the conductive plate 30 and the power contact portion 21, between the conductive plate 30 and the signal trigger portion 22, or between the conductive plate 30 and the power body portion 24. Hence, the “the conductive plate 30 is independent of the power terminal 20” mentioned in the embodiment refers that: the conductive plate 30 and the power terminal 20 do not establish any connection or contact before the insert 8 is inserted into the slot 11.

In the embodiment, orthographic projections of the elastic fingers 23 of the power terminal 20 on the conductive plate 30 fall within the conductive plate 30. That is, orthographic projections of the power contact portion 21 and the signal trigger portion 22 of the power terminal 20 on the conductive plate 30 fall within the conductive plate 30, thereby ensuring that the signal trigger portion 22 can accurately touch or contact with the conductive plate 30.

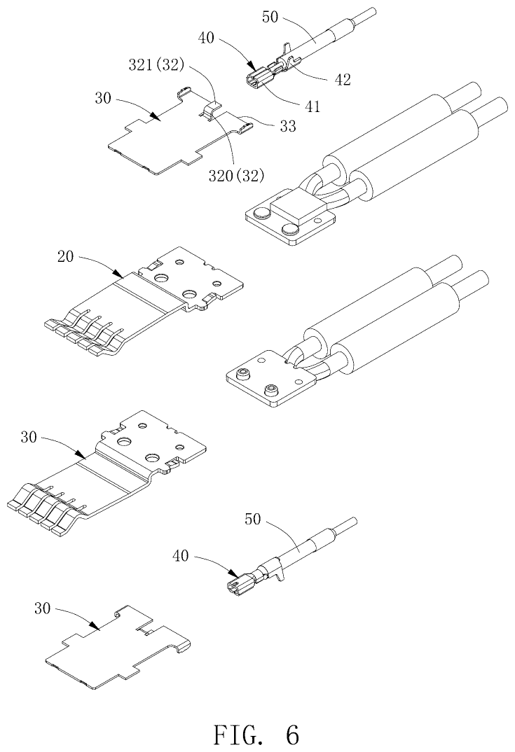

Moreover, referring to FIG. 6, the conductive plate 30 has a conductive connection sheet 32, which is disposed near a mounting edge 33 facing the mounting side 13 of the insulation case 10, and especially disposed near the middle position of the mounting edge 33, but can also be set at any position of the mounting edge 33. By disposing the conductive connection sheet 32 near the mounting edge 33 or on the mounting edge 33, the width of the conductive plate 30 does not need to be increased, thereby saving space of the insulation case 10 in a width direction W (label seen in FIG. 2), and providing a narrower size power connector 1.

Further, as shown in FIG. 6, the conductive connection sheet 32 is bent to be L-shaped, and has a vertical section 320 and a horizontal section 321. The vertical section 320 extends away from the power terminal 20, and the horizontal section 321 extends toward the mounting side 13 of the insulation case 10.

Please refer to FIG. 6, the signal cable-fixing unit 40 has a first end portion 41 and a second end portion 42 arranged opposite to each other. The first end portion 41 is connected to the conductive connection sheet 32 (especially the horizontal section 321), and the second end portion 42 is connected to the signal cable 50. Specifically, the first end portion 41 is a frame to be used to fix the signal cable-fixing unit 40 into the insulation case 10. The second end portion 42 is a sheet that can wrap around an outer skin of the signal cable 50. A center wire of the signal cable 50 is welded to the signal cable-fixing unit 40 or the conductive connection sheet 32. In summary, the signal cable 50 can be indirectly electrically connected to the conductive plate 30 by welding to the signal cable-fixing unit 40, and can be directly electrically connected to the conductive plate 30 by welding to the conductive plate 30.

Please refer to FIG. 6, the signal cable-fixing unit 40 and the conductive plate 30 are configured as a two-piece structure, and the signal cable-fixing unit 40 is connected to the conductive plate by welding. In other embodiments, the signal cable-fixing unit 40 and the conductive plate 30 are configured as a one-piece structure by a stamping process.

In the embodiment, as shown in FIGS. 4 and 5, the power connector 1 of the present application includes at least one pair of power terminals, at least one pair of conductive plates, and at least one pair of signal cable-fixing units.

Referring to FIGS. 4 and 5, the pair of power terminals includes two of the power terminals 20 as described above, which can be respectively referred to as a first power terminal and a second power terminal. During assembly, the first power terminal and the second power terminal have identical structures and are symmetrically arranged in the insulation case 10. The first power terminal and the second power terminal are located on two opposite vertical sides of the slot 11 (including a lower side and an upper side of the slot 11 in FIG. 1) for being used to make electrical contact with two opposing insertion surfaces 80 of the insert 8. Each power terminal 20 has multiple of the power contact portions 21 arranged in a row and multiple of the signal trigger portions 22 arranged in a row. Each power contact portion 21 protrudes into the slot 11 and is used to make electrical contact with the insert 8, and each signal trigger portion 22 is forced to move in a direction away from the slot 11 after the power contact portion 21 makes electrical contact with the insert 8.

Referring to FIGS. 4 and 5, the pair of conductive plates includes two of the conductive plates 30 as described above, which can be respectively referred to as a first conductive plate and a second conductive plate. During assembly, the first conductive plate and the second conductive plate have identical structures and are symmetrically arranged in the insulation case 10. Each conductive plate 30 is corresponding to one power terminal 20 and is independent of the corresponding power terminal 20. Each conductive plate 30 is located on a movement path of the signal trigger portion 22 of the corresponding power terminal 20. The conductive plate 30 makes electrical contact with the signal trigger portion 22 of the corresponding power terminal 20 after the power contact portion 21 of the corresponding power terminal 20 makes electrical contact with the insert 8, and breaks electrical contact with the signal trigger portion 22 of the corresponding power terminal 20 after the insert 8 withdraws from the slot 11 and releases the power contact portion 21 of the corresponding power terminal 20.

More specifically, the first conductive plate is corresponding to the first power terminal and is independent of the first power terminal. The second conductive plate is corresponding to the second power terminal and is independent of the second power terminal.

Referring to FIG. 4, the pair of signal cable-fixing units includes two of the signal cable-fixing units 40 as described above, which can be respectively referred to as a first signal cable-fixing unit and a second signal cable-fixing unit. The pair of signal cable-fixing units have identical structures and are symmetrically arranged in the insulation case. Each signal cable-fixing unit 40 is connected to the corresponding conductive plate 30 and is used to fix a corresponding signal cable 50. Specifically, the first signal cable-fixing unit and the second signal cable-fixing unit are respectively connected to the first conductive plate and the second conductive plate, and are used to fix two signal cables 50. Therefore, the two signal cables 50 are respectively connected to the first conductive plate and the second conductive plate and are used to transmit power supply signals.

Referring to FIG. 3, in the pair of power terminals 20, the power contact portions 21 is used to commonly hold the insert 8. A distance D1 between the power cable connection portions 25 of the first and second power terminals is less than a distance D2 between the power body portion 24 of the first and second power terminals.

As described above, the power connector 1 of the present application does not generate an arc between the power terminal 20 and the insert 8 during power supply, as the power terminal 20 has already made electrical contact with the insert 8 before power supply. Moreover, the power connector 1 of the present application employs the power terminal 20 to directly contact the conductive plate 30 for triggering a power supply signal, thereby shortening the trigger time of the power supply signal and timely supplying power to the insert 8. Furthermore, the power connector 1 of the present application also saves space and makes the structure more compact because no additional signal trigger mechanism is required.

It should be understood that, the application of the present application is not limited to the above examples listed. Ordinary technical personnel in this field can improve or change the applications according to the above descriptions, all of these improvements and transforms should belong to the scope of protection in the appended claims of the present application.

What is claimed is:

1. A power connector, comprising:
an insulation case, having a slot for inserting an insert;
at least one power terminal, being disposed in the insulation case and having at least one power contact portion and at least one signal trigger portion; wherein, the power contact portion protrudes into the slot and is used to first make electrical contact with the insert when the insert is inserted into the slot, and the signal trigger portion is forced to move in a direction away from the slot after the power contact portion makes electrical contact with the insert;
at least one conductive plate, being disposed in the insulation case, being located on one side of the power terminal facing away from the slot and being independent of the power terminal; wherein, the conductive plate makes electrical contact with the signal trigger portion after the power contact portion makes electrical contact with the insert, and breaks electrical contact with the signal trigger portion after the insert withdraws from the slot and releases the power contact portion; and
at least one signal cable-fixing unit, being connected to the conductive plate and being used to fix a signal cable; wherein, the signal cable is connected to the conductive plate and is used to transmit a power supply signal when the conductive plate is in electrical contact with the signal trigger portion.

2. The power connector according to claim 1, wherein,
the signal cable-fixing unit and the conductive plate are configured as a one-piece structure by a stamping process.

3. The power connector according to claim 1, wherein,
the signal cable-fixing unit and the conductive plate are configured as a two-piece structure, and the signal cable-fixing unit is welded and connected to the conductive plate.

4. The power connector according to claim 1, wherein,
the power terminal has multiple power contact portions arranged in a row and multiple signal trigger portions arranged in a row.

5. The power connector according to claim 4, wherein,
the power terminal is provided with multiple elastic fingers arranged in a row; each of the elastic fingers has a protruding portion formed by bending toward the slot and a free end away from the slot and close to the conductive plate;
the protruding portion is used as the power contact portion; and
the free end is used as the signal trigger portion.

6. The power connector according to claim 5, wherein,
the conductive plate is a flat plate;
the conductive plate and the power terminal are arranged in parallel along a width direction of the slot, and define a gap;
orthographic projections of the power contact portion and the signal trigger portion on the conductive plate fall within the conductive plate.

7. The power connector according to claim 1, wherein,
the insulation case has a mating side and a mounting side, and the slot is located on the mating side.

8. The power connector according to claim 7, wherein,
the conductive plate has a conductive connection sheet disposed near a mounting edge, and the mounting edge faces the mounting side; and
the signal cable-fixing unit has a first end portion and a second end portion arranged opposite to each other;
wherein the first end portion is connected to the conductive connection sheet, and the second end portion is connected to the signal cable.

9. The power connector according to claim 8, wherein,
the conductive connection sheet is bent into an L-shape, with a vertical section and a horizontal section; the vertical section extends away from the power terminal, and the horizontal section extends toward the mounting side;
the first end portion of the signal cable-fixing unit is connected to the horizontal section.

10. The power connector according to claim 5, wherein,
the power terminal has a power body portion and a power cable connection portion; the multiple elastic fingers are connected to a front end of the power body portion, and the power cable connection portion is connected to a rear end of the power body portion;
the power cable connection portion is used to be fixedly connected with at least one power cable.

11. The power connector according to claim 10, wherein,
the power terminal is bent vertically twice to form a Z-shape;
the power cable connection portion is connected with the power cable by a welding plate; and
the welding plate is fixed on one side of the power cable connection portion facing the conductive plate.

12. A power connector, comprising:
an insulation case, having a slot for inserting an insert;
at least one pair of power terminals, including a first power terminal and a second power terminal that have identical structures and are symmetrically arranged in the insulation case; the first power terminal and the second power terminal being located on two opposite vertical sides of the slot for being used to make electrical contact with two opposing insertion surfaces of the insert; each of the first power terminal and the second power terminal having at least one power contact portion and at least one signal trigger portion; wherein, the power contact portion protrudes into the slot and is used to first make electrical contact with the insert when the insert is inserted into the slot, and the signal trigger portion is forced to move in a direction away from the slot after the power contact portion makes electrical contact with the insert;
at least one pair of conductive plates, including a first conductive plate and a second conductive plate that have identical structures and are symmetrically arranged in the insulation case; the first conductive plate being independent of the first power terminal and being located on a movement path of the signal trigger portion of the first power terminal; the second conductive plate being independent of the second power terminal and being located on a movement path of the signal trigger portion of the second power terminal; wherein, the first conductive plate makes electrical contact with the signal trigger portion of the first power terminal after the power contact portion of the first power terminal makes electrical contact with the insert, and breaks electrical contact with the signal trigger portion of the first power terminal after the insert withdraws from the slot and releases the power contact portion of the first power terminal; and wherein, the second conductive plate makes electrical contact with the signal trigger portion of the second power terminal after the power contact portion of the second power terminal makes electrical contact with the insert, and breaks electrical contact with the signal trigger portion of the second power terminal after the insert withdraws from the slot and releases the power contact portion of the second power terminal; and
at least one pair of signal cable-fixing units, including a first signal cable-fixing unit and a second signal cable-fixing unit that have identical structures, are symmetrically arranged in the insulation case, and are respectively connected to the first conductive plate and the second conductive plate; each of the first signal cable-fixing unit and the second signal cable-fixing unit being used to fix a signal cable.

13. The power connector according to claim 12, wherein,
each of the first power terminal and the second power terminal is Z-shaped, and has a power body portion and a power cable connection portion; and
a distance between the power cable connection portions of the first and second power terminals is less than a distance between the power body portion of the first and second power terminals.
